(19) United States
(12) Patent Application Publication
(10) Pub. No.: US 2005/0033493 A1
(43) Pub. Date: Feb. 10, 2005

(54) Vehicle-mounted electronic control apparatus

(75) Inventors: Daisuke Eguchi, Tokyo (JP); Shoso Tsunekazu, Tokyo (JP); Jiro Sumitani, Tokyo (JP); Takanori Fujimoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/841,486

(22) Filed: May 10, 2004

(30) Foreign Application Priority Data
Aug. 9, 2003 (JP) 2003-315639

(51) Int. Cl. G06F 19/00

(52) U.S. Cl. 701/36; 701/102

(57) ABSTRACT

A vehicle-mounted electronic control apparatus can automatically adjust an amount of checksum calculation to be executed at the time of each periodic processing. A checksum calculation processing section (20) for calculating the value of a checksum in a memory (4) in a divided manner at each timing (Ta) of execution of periodic processing executes one checksum calculation processing operation of a fixed number of bytes, makes a comparison between a current time (Tc) and a processing end limit time (Tb) at which the execution of the periodic processing should be ended, after execution of the checksum calculation processing operation, executes the checksum calculation processing again when a period of time from the current time (Tc) to the processing end limit time (Tb) has a margin greater than or equal to a predetermined time (Tr), and interrupts the checksum calculation processing operation when there is no sufficient margin.

### BACKGROUND OF THE INVENTION

1. Field of the Invention

The present invention relates to a vehicle-mounted electronic control apparatus that performs a variety of kinds of control on a vehicle engine or on-vehicle equipment, and more particularly, a vehicle-mounted electronic control apparatus having a checksum calculation processing section that adds data in a memory in a microcomputer to calculate checksum values thereof at each timing of execution of periodic processing.

2. Description of the Related Art

Conventionally, in vehicle-mounted electronic control apparatuses using microcomputers, there have been proposed various techniques for calculating checksum values for a memory so as to verify the validity of programs and data in the memory, or to prevent an illegal rewriting of the memory.

Specifically, the following technique is known in general markets. That is, the value of a checksum in an entire ROM is calculated, and it is then determined whether the checksum value thus calculated is true. When it is not true, programs or data stored in the ROM are considered to be abnormal, and a safety precaution is adopted such as changing the operation of a related microcomputer or electronic control apparatus controlled by using such programs and/or data from a normal mode to a failure mode.

Such memory checksum calculation processing is carried out by a CPU in the microcomputer installed on the vehicle-mounted electronic control apparatus in parallel with various kinds of engine control operations. In this case, however, the larger the capacity or size of the memory for which the checksum value is calculated, the greater does the load of the CPU due to the checksum calculation processing become, thus giving impediment or interference to the various kinds of engine control operations.

Accordingly, the following devices have been proposed in recent years. That is, the calculation of checksums is not executed at a time but it is instead carried out with time sharing so as to distribute in time the load on the CPU, whereby the checksum calculation processing can be executed in parallel with the engine control (for instance, see a first patent document: Japanese patent application laid-open No. 2001-227402).

In such a type of known electronic control apparatus, for the purposes of making efficient use of the CPU as well as avoiding an overload of the CPU due to the checksum calculation processing, when the checksum value is calculated with time sharing, the CPU load at the time of checksum calculation is measured based on the number of revolutions per minute of the engine, etc., without fixing the number of bytes to be added at a time, so that addition processing is carried out after the number of bytes for which checksum calculation can be made at that time has been estimated.

In the known vehicle-mounted electronic control apparatus, since the number of bytes to be added is estimated before checksum calculation processing is executed, there arises the following problem. That is, when interrupt processing of high priority takes place in the course of checksum calculation processing, the CPU might be overloaded, and in order to avoid such a situation, it is necessary to set the estimated number of bytes to be added to a value having a certain margin, thus making it difficult to improve the efficiency of the CPU to an extent of 100%.

In addition, in the known vehicle-mounted electronic control apparatus, the grounds for the estimation of the number of bytes to be added at the time of checksum calculation depend strongly on the inherent performance of hardware (e.g., processing power and memory access speed of the CPU, etc), thus giving rise to another problem. That is, if the configuration of hardware is changed (i.e., the CPU is replaced with a new one having higher processing power), there will be the necessity for reviewing or reevaluating the estimation processing of the number of bytes to be added, and hence the management and porting of related software cannot be performed easily.

### SUMMARY OF THE INVENTION

The present invention is intended to obviate the problems as referred to above, and has for its object to obtain a vehicle-mounted electronic control apparatus which is capable of operating a microcomputer in a most efficient manner thereby to shorten the processing time thereof until the completion of checksum calculation without causing impediment or interference to the processing of a CPU other than the checksum calculation.

Bearing the above object in mind, according to the present invention, there is provided a vehicle-mounted electronic control apparatus including a microcomputer, and a memory for storing various control programs and data related to the microcomputer, the microcomputer being operable to generate, based on detection signals from various kinds of sensors installed on a vehicle, drive signals for various kinds of actuators to determine the operating conditions of the vehicle. The microcomputer includes a checksum calculation processing section for calculating the value of a checksum in the memory in a divided manner at each timing of execution of the periodic processing which is regularly executed. The checksum calculation processing section automatically adjusts an amount of checksum calculations at each timing of execution of the periodic processing by executing one checksum calculation processing operation of a fixed number of bytes at the time of executing the checksum calculation processing, by making a comparison between a current time and a processing end limit time at which the execution of the periodic processing should be ended, after execution of the checksum calculation processing operation, by executing the checksum calculation processing operation again when a period of time from the current time to the processing end limit time has a margin which is greater than or equal to a predetermined time, and by interrupting the checksum calculation processing operation when the margin of the period of time is less than the predetermined time.

According to the present invention, a checksum of the fixed number of bytes, which will not influence the processing of the CPU under a high load thereof, is calculated each time periodic processing is executed. After one checksum calculation processing operation has been carried out, a comparison is made between the current time and the processing end limit time, and if there is a sufficient time margin therebetween (i.e., if a difference between the current time and the processing end limit time exceed a prescribed value, a checksum of the fixed number of bytes is calculated again, whereas if there is no sufficient time margin therebetween, the checksum calculation processing is interrupted so that the amount of checksum calculation at each periodic processing is automatically adjusted. That is, the processing load of the CPU is low so as to permit the periodic processing to be performed with a certain margin, checksum calculation processing of the fixed number of bytes is repeated. On the contrary, when the CPU processing load is high so that the periodic processing can be made within the processing limit time with no or little margin, the checksum calculation processing of the fixed number of bytes is executed one time alone.

As a result, the use efficiency of the CPU at a low CPU load can be improved, and at the same time, the period of time until the checksum calculation has been completed can be shortened without causing impediment or interference to the processing of the CPU when the CPU load is high.

The above and other objects, features and advantages of the present invention will become more readily apparent to those skilled in the art from the following detailed description of a preferred embodiment of the present invention taken in conjunction with the accompanying drawings.

### BRIEF DESCRIPTION OF THE DRAWINGS

FIG. 1 is a block diagram showing a vehicle-mounted electronic control apparatus according to one embodiment of the present invention.

FIG. 2 is a functional block diagram concretely showing a checksum calculation processing section according to the embodiment of the present invention.

FIG. 3 is a flow chart showing an initialization process according to the embodiment of the present invention.

FIG. 4 is a flow chart showing a basic process according to the embodiment of the present invention.

FIG. 5 is a flow chart showing an interrupt process according to the embodiment of the present invention.

FIG. 6 is a flow chart concretely showing a checksum calculation process according to the embodiment of the present invention.

FIG. 7 is a flow chart concretely showing a ROM checksum determination process according to the embodiment of the present invention.

FIGS. 8A through 8E are timing charts showing the operation of the vehicle-mounted electronic control apparatus according to the embodiment of the present invention.

### DESCRIPTION OF THE PREFERRED EMBODIMENTS

Now, a preferred embodiment of the present invention will be described below in detail while referring to the accompanying drawings. Embodiment 1.

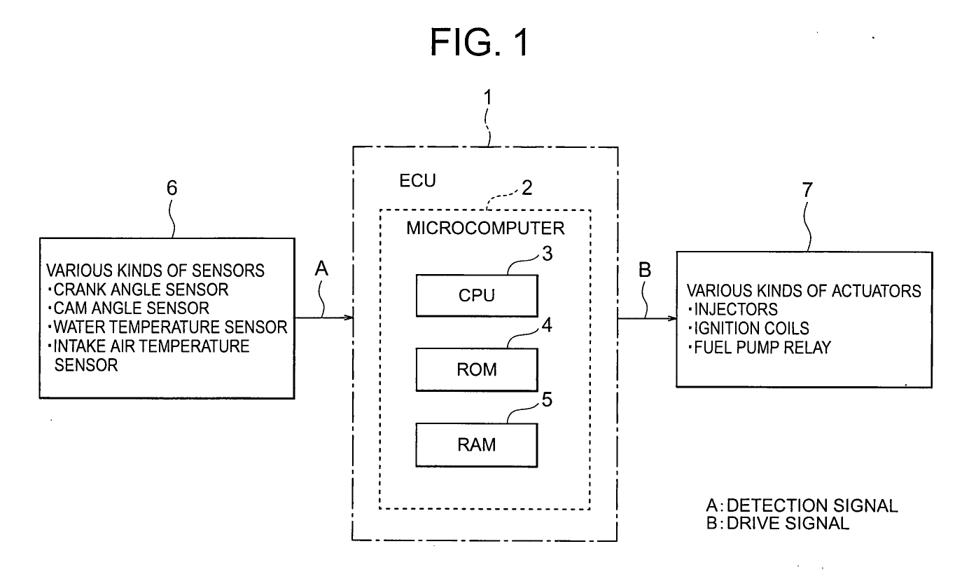

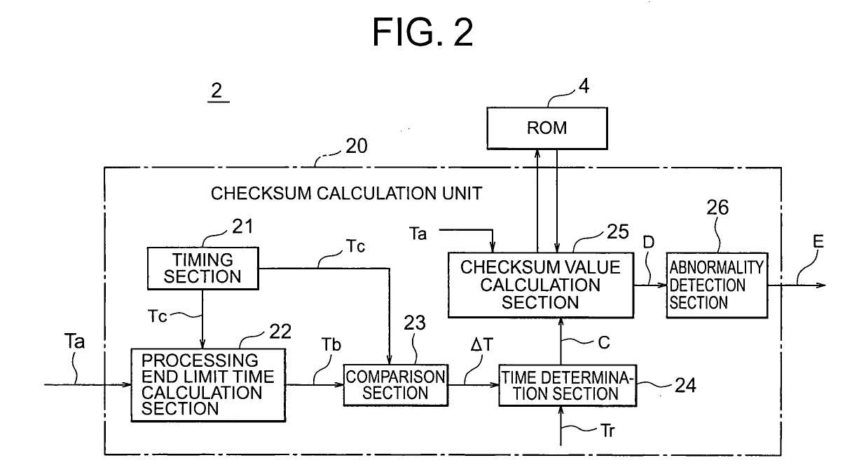

FIG. 1 is a block diagram that schematically illustrates a vehicle-mounted electronic control apparatus according to one embodiment of the present invention, and FIG. 2 is a functional block diagram that concretely shows a checksum calculation processing section according to the embodiment of the present invention.

Here, reference is made to the case where the vehicle-mounted electronic control apparatus for controlling an internal combustion engine of a vehicle is constituted by an electronic control unit 1 (hereinafter referred to as an “ECU”) having a microcomputer 2 built therein.

In FIG. 1, the ECU 1 is mainly composed of the microcomputer 2, which includes a CPU 3 that executes a variety of kinds of control processes, a ROM (nonvolatile memory) 4 that stores various control programs and data with parameters related to the microcomputer 2 (i.e., CPU 3), a RAM (temporary storage memory) 5 that stores processed data, and other elements (an A/D converter, I/O ports, a free run counter, a timer, etc.) not shown in the figure.

Detection signals A from various kinds of sensors 6 (a crank angle sensor, a cam angle sensor, a water temperature sensor, an intake air temperature sensor, etc.) installed on the vehicle are input to the ECU 1.

In addition, drive signals B for various kinds of actuators 7 (injectors, ignition coils, a fuel pump relay, etc.) to determine the operating conditions of the vehicle are output from the ECU 1 to these actuators 7.

The detection signals A from the various kinds of sensors 6 indicate the operating conditions of the engine.

The ECU 1 executes arithmetic or calculation processing in accordance with the engine operating conditions through the processing in the microcomputer 2, and generates the drive signals B for controlling the various kinds of actuators 7 connected with external devices.

That is, the microcomputer 2 calculates and generates the drive signals B for the injectors and the ignition coils based on the detection signals A and calculations using a map of parameters in the ROM 4 and data in the RAM 5, whereby it executes a variety of kinds of basic engine control operations (e.g., fuel injection control, ignition timing control, etc.).

Moreover, the microcomputer 2 in the ECU 1 is provided with a checksum calculation processing section 20, as shown in FIG. 2.

In FIG. 2, the checksum calculation processing section 20 calculates a checksum value D in the ROM 4 in a divided manner at each execution timing Ta of the periodic processing regularly executed, and detects data abnormality in the ROM 4 based on the checksum value D thus calculated.

The checksum calculation processing section 20 includes a timing section 21 for measuring a current time Tc, a processing end limit time calculation section 22 for calculating, based on the execution timing Ta of the periodic processing and the current time Tc, a processing end limit time Tb by which the execution of the periodic processing should be ended, a comparison section 23 for calculating a difference between the current time Tc and the processing end limit time Tb as a float or margin time ΔT, a time determination section 24 for determining whether the margin time ΔT thus calculated has a satisfactory margin in comparison with a predetermined time Tr (i.e., whether the margin time is greater than or equal to the predetermined time Tr), a checksum value calculation section 25 for calculating the checksum value D of the data in the ROM 4 in response to the execution timing Ta of the periodic processing and the determination result C of the time determination section 24, and an abnormality detection section 26 for outputting an abnormality detection signal E when the checksum value D indicates abnormality.

With the above construction, the checksum calculation processing section 20 executes checksum calculation processing of a fixed number of bytes (necessary minimum), which does not influence the processing of the CPU 3 under a high load thereof, once at the time of execution of the checksum calculation processing, and makes a comparison between the processing end limit time Tb and the current time Tc after having executed the checksum calculation processing. When there is a sufficient duration or margin from the current time Tc to the processing end limit time Tb (i.e., the margin is greater than or equal to the predetermined time Tr), the checksum calculation processing section 20 executes checksum calculation processing again, whereas when there is no sufficient margin, the checksum calculation processing is interrupted. In this manner, the amount of checksum calculation at each execution timing Ta of the periodic processing is automatically adjusted.

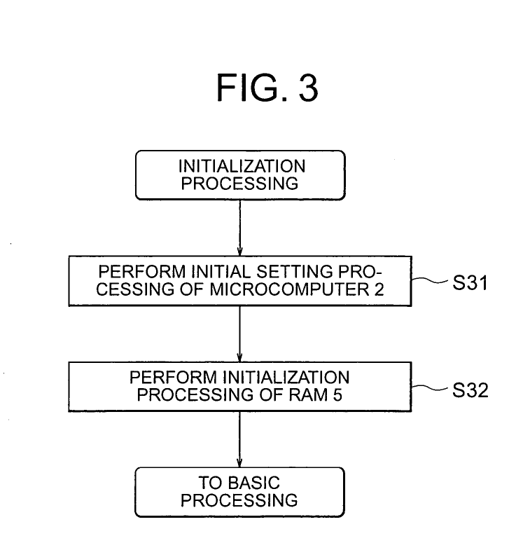

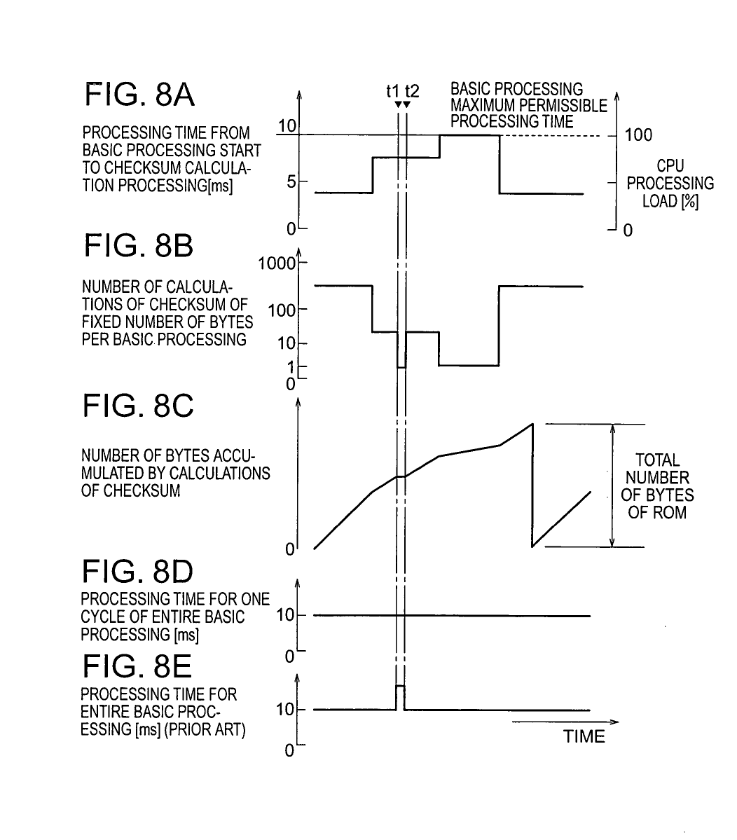

Hereinafter, a detailed description will be made of the concrete operation of this embodiment of the present invention shown in FIGS. 1 and 2 while referring to flow charts of FIGS. 3 through 7 and timing charts of FIGS. 8A through 8E.

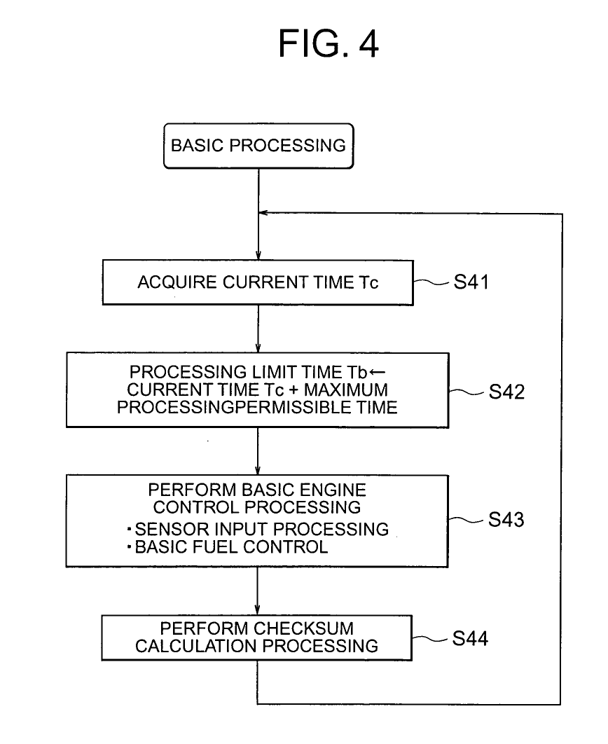

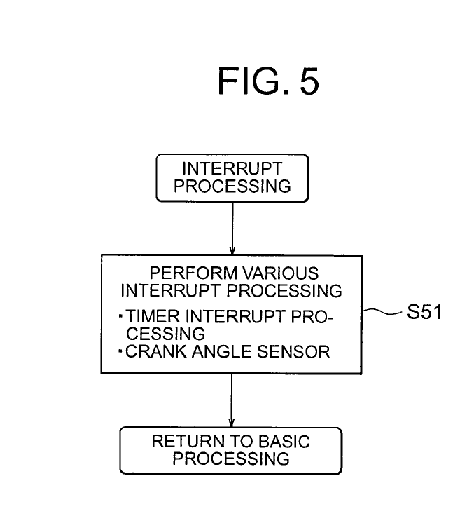

FIGS. 3 through 7 show various program processes or processings executed by the CPU 3 in the microcomputer 2, wherein FIG. 3 is initialization processing, FIG. 4 is basic processing (periodic processing), and FIG. 5 is interrupt processing.

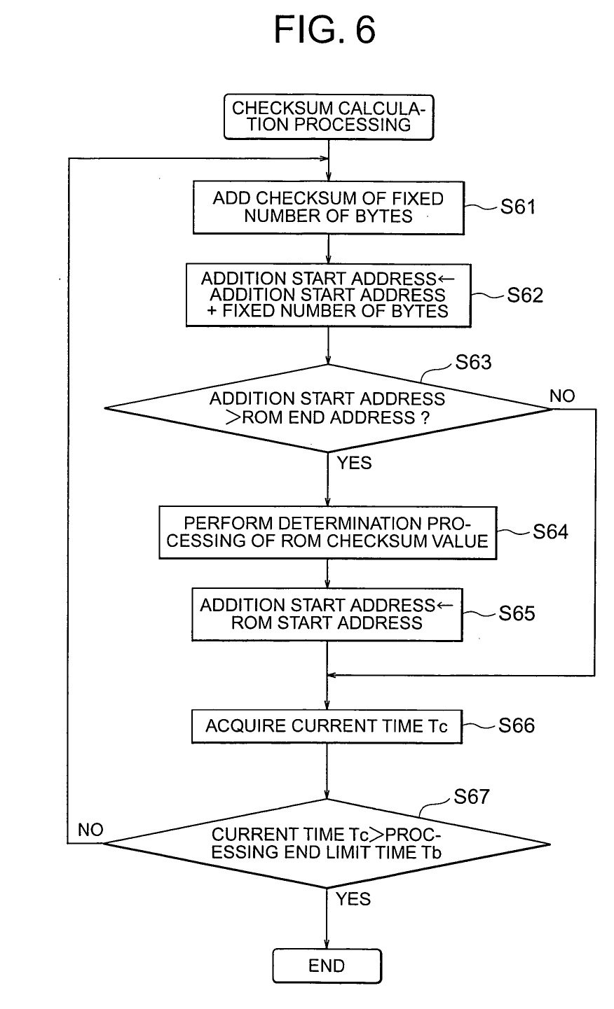

FIG. 6 concretely shows the calculation processing of the checksum D (step S44) following basic engine control processing (step S43) in FIG. 4.

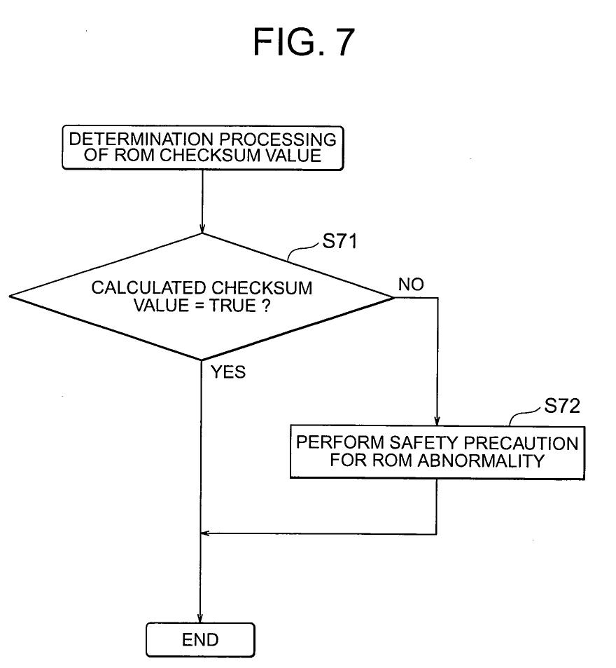

Further, FIG. 7 concretely shows ROM checksum determination processing (step S64) in FIG. 6.

Upon actuation of the ECU 1, initialization processing (FIG. 3) is first executed, and basic processing (FIG. 4) is then executed. Thereafter, the basic processing (FIG. 4) is repeatedly executed.

In addition, when an interrupt processing request according to the crank angle sensor signal, an interrupt processing request according to the free run timer in the microcomputer 2 or the like is generated, the basic processing (FIG. 4) is interrupted, and interrupt processing (FIG. 5) is executed.

After the interrupt processing (FIG. 5) is completed, a return to the basic processing (FIG. 4) is performed again, and the basic processing is executed continuously. The checksum calculation processing in the basic processing (FIG. 4) is executed as a part of the basic processing each time the basic processing is executed.

First of all, the initialization processing will be described while referring to FIG. 3.

As shown in FIG. 3, upon actuation of the ECU 1, the microcomputer 2 executes the initialization processing of the microcomputer 2 (step S31) and the initial setting processing of the RAM 5 (step S32), and then the control flow advances to the basic processing (FIG. 4).

Now, the basic processing will be described while referring to FIG. 4.

In FIG. 4, the processing end limit time calculation section 22 first acquires a current time Tc from the timing section (free run counter) 21 (step S41), and calculates a processing end limit time Tb by adding a maximum processing permissible time to the current time Tc (step S42).

Subsequently, an engine control section in the ECU 1 executes basic engine control processing (step S43). That is, the process of inputting the detection signals A from the various kinds of sensors 6 is performed, and at the same time, the process of outputting the drive signals B for the various kinds of actuators 7 (e.g., basic fuel injection control according to the injectors) in accordance with the engine operating conditions as indicated by the detection signals A is carried out.

Moreover, the checksum value calculation section 25 performs checksum calculation processing at each execution timing Ta of the basic engine control processing (periodic processing)(step S44).

Hereinafter, a return is performed to the step S41, and the basic processing of FIG. 4 is repeatedly executed as long as there is no interrupt processing (FIG. 5) generated.

As stated above, the current time Tc is acquired from the free run counter value in the microcomputer 2 before the basic engine control processing (step S43) is executed (step S41), and the value obtained by adding the maximum processing permissible time stored in the ROM 4 to the current time Tc is stored in the RAM 5 as an end limit time Tb of the basic processing (step S42).

Here, note that the maximum processing permissible time is a maximum processing time permitted for each execution of the basic processing, and it is determined by the system of the vehicle on which the subject electronic control apparatus is mounted.

The last checksum calculation processing (step S44) is called from the basic processing (FIG. 4) as a subroutine, and it is executed in such a manner as shown in FIG. 6.

Also, as shown in FIG. 5, when interrupts are generated, corresponding various interrupt processes are executed (step S51), and thereafter the control flow is returned to the basic processing (FIG. 4).

Next, the checksum calculation processing (step S44) in FIG. 4 will be explained in detail while referring to FIG. 6.

In FIG. 6, first of all, the calculation processing of a checksum value for a fixed number of bytes (checksumming) is carried out (step S61).

At this time, the fixed number of bytes is set to such a value for which the influence of one checksum calculation process on the processing of the CPU 3 can be disregarded.

Subsequently, an addition (checksumming) start address in the last processing cycle is added by the fixed number of bytes to provide an updated addition start address for the following processing cycle (step S62). Then, the thus updated addition start address is compared with the end or last address of the ROM 4, so that it is determined whether the updated addition start address exceeds the ROM end address (step S63).

If it is determined in step S63 that the updated addition start address is below or smaller than the ROM end address (that is, NO), the control flow proceeds to step S66 which will be described later, whereas if it is determined that the updated addition start address exceeds the ROM end address (that is, YES), the entire checksum calculation of the ROM 4 is completed, and the abnormality detection section 26 performs abnormality determination processing by making reference to the thus calculated checksum value D of the ROM 4 (step S64).

As a concrete example of the evaluation and determination processing for the checksum value D (step S64), a subroutine shown in FIG. 7 is called and executed.

In FIG. 7, it is determined whether the calculated checksum value D coincides with a true value (step S71), and if it is determined that there is coincidence therebetween (that is, YES), the subroutine of FIG. 7 is ended, whereas if it is determined that there is no coincidence therebetween (that is, NO), an abnormality detection signal E is generated and a safety precaution for abnormality of the ROM 4 is taken (step S72). Thereafter, the subroutine of FIG. 7 is ended, and a return to the processing of FIG. 6 is carried out.

That is, if the evaluation result of the checksum value D is “true”, the processing is ended as it is, whereas if the evaluation result is “false”, a safety precaution at the time of ROM abnormality (step S72) is taken so as to prevent the vehicle from becoming unstable. For the safety precaution at this time, a measure such as changing the engine control mode from an ordinary processing mode into a limp home mode is adopted in response to the abnormality detection signal E.

In FIG. 6, the calculation processing of the checksum value D of the ROM 4 is repeatedly carried out so that the presence or absence of abnormality is constantly evaluated in step S64. Accordingly, after the end of step S64, the first address of the ROM 4 is updated and set as an addition start address in preparation for the next calculation (step S65).

Then, the comparison section 23 acquires again a current time Tc from the timing section (free run counter) 21 in the microcomputer 2 (step S66), and compares the current time Tc with the processing end limit time Tb stored in the RAM 5. The time determination section 24 determines whether the current time Tc exceeds the processing end limit time Tb (i.e., whether there exists the float or margin time ΔT or not)(step S67).

In this case, it is assumed that the predetermined time Tr acting as a determination reference or criterion is set to about “0”.

If it is determined as Tc>Tb in step S67 (that is, YES), the checksum calculation processing of FIG. 6 is ended, and a return to the basic processing (FIG. 4) is performed.

On the other hand, if it is determined as Tc≦Tb in step S67 (that is, NO), a return to step S61 is performed, and the processes in steps S61 through S67 are repeatedly executed until the determination result C in step S67 becomes positive (that is, YES).

FIGS. 8A through 8E are the timing charts showing the time-related changes of the above-mentioned operations in mutual association with each other, wherein FIG. 8A shows a processing time [msec] from the first processing (step S41) of the basic processing (FIG. 4) to just before the checksum calculation processing (step S44); FIG. 8B shows the number of checksum calculations of the fixed number of bytes; FIG. 8C shows the relation between the number of bytes accumulated by checksum additions of the ROM 4 and the time elapsed; FIG. 8D shows the processing time of the entire basic processing in one cycle including checksum calculation processing; and FIG. 8E shows the processing time of the entire basic processing in a conventional apparatus for an easy understanding of advantageous effects due to the embodiment of the present invention.

In FIGS. 8A through 8E, the maximum permissible processing time of the basic processing is set to 10 [msec].

In FIG. 8A, the processing time shown therein varies greatly depending upon the number of occurrences of interrupt processing generated in the course of the basic processing from step S41 to step S44.

Here, note that a portion in which the processing time is short corresponds to a low-load period of the CPU 3 in which there are only a small number of interrupt processing requests in the microcomputer 2 and hence the number of revolutions per minute of the engine is low, whereas a portion in which the processing time is long corresponds to a high-load period of the CPU 3 in which there is a lot of interrupt processing requests and hence the number of revolutions per minute of the engine is high.

In FIGS. 8A and 8B, when the processing load of the CPU 3 is low, a greater number of checksum calculation processing operations of the fixed number of bytes are executed, whereas when the processing load of the CPU 3 is high, a smaller number of checksum calculation processing operations of the fixed number of bytes are executed.

The number of bytes accumulated by checksum additions of the ROM 4 shown in FIG. 8C increases greatly or at a high rate with the passage of time in the case of the low processing load of the CPU 3, but it increases slowly or at a low rate with respect to the time elapsed in the case of the high processing load of the CPU 3. Accordingly, FIG. 8C illustrates the state where the entire checksum value D of the ROM 4 is being calculated depending upon the processing load of the CPU 3.

In addition, as clear from the processing time (e.g., constant at 10 [msec]) indicated in FIG. 8D, it will be understood that the entire processing load of the CPU 3 including the checksum calculation processing is held constant even when the processing load of the CPU 3 due to other than the checksum calculation processing is varied, and the checksum calculation processing is carried out by making efficient use of the CPU 3.

For instance, even if interrupt processing of high priority and a high processing load is generated in a period from a first time point t1 to a second time point t2 during or immediately after an addition process in the checksum calculation processing, the processing load of the CPU 3 is constant, as shown in FIG. 8D.

On the other hand, in the conventional apparatus, the number of bytes to be addition at a time, after once decided in a checksum calculation processing section, is not reviewed or reevaluated until the checksum calculation processing is completed. Accordingly, the processing load of the CPU 3 increases abruptly at the timing when interrupt processing of a high processing load is generated from the first time point t1 to the second time point t2, as shown by the processing time indicated in FIG. 8E, with the result that the maximum permissible processing time is exceeded.

In this manner, an abrupt increase in the processing load of the CPU 3 results in giving a harmful influence on the basic engine control processing (step S43) executed in the basic processing (FIG. 4), and hence is undesirable.

In contrast to this, in this embodiment of the present invention, the checksum calculation processing is discontinued immediately at the instant when interrupt processing of a high load (e.g., from the time point t1 to the time point t2) is generated, as shown in FIG. 8B. Therefore, the entire processing time becomes constant as shown in FIG. 8D, and there will be no marked increase in the processing load of the CPU 3 due to the checksum calculation processing even in a period from the time point t1 to the time point t2.

As described above, according to the checksum calculation processing of the above-mentioned embodiment of the present invention, first of all, the calculation of a checksum of a fixed number of bytes, which does not influence the processing load of the CPU 3, is carried out at each timing of execution of the basic processing (FIG. 4), and thereafter, when there is a margin in the processing time of the CPU 3, the checksum calculation processing of the fixed number of bytes is repeated, thereby making it possible to efficiently use the CPU 3 in an automatic fashion. In addition, even at the time of generation of interrupt processing or the like, the checksum calculation can be executed without the CPU 3 being subjected to an overload state.

Moreover, since the above processing is irrelevant to hardware-dependent processing contents such as the ability of the CPU 3, the memory access speed thereof and the like, there will not be incurred any work such as program corrections, management of program kinds, etc., as would otherwise be required upon change or replacement of hardware in the conventional apparatus. Consequently, the present invention can provide a system of high versatility.

While the invention has been described in terms of a preferred embodiment, those skilled in the art will recognize that the invention can be practiced with modifications within the spirit and scope of the appended claims.

1. A vehicle-mounted electronic control apparatus comprising a microcomputer, and a memory for storing various control programs and data related to said microcomputer, said microcomputer being operable to generate, based on detection signals from various kinds of sensors installed on a vehicle, drive signals for various kinds of actuators to determine the operating conditions of the vehicle,
wherein said microcomputer includes a checksum calculation processing section for calculating the value of a checksum in said memory in a divided manner at each timing of execution of the periodic processing which is regularly executed; and
said checksum calculation processing section automatically adjusts an amount of checksum calculations at each timing of execution of said periodic processing by;
executing one checksum calculation processing operation of a fixed number of bytes at the time of executing the checksum calculation processing;
making a comparison between a current time and a processing end limit time at which the execution of said periodic processing should be ended, after execution of said checksum calculation processing operation;
executing said checksum calculation processing operation again when a period of time from said current time to said processing end limit time has a margin which is greater than or equal to a predetermined time; and
interrupting said checksum calculation processing operation when said margin of said period of time is less than said predetermined time.

2. The vehicle-mounted electronic control apparatus as set forth in claim 1, wherein said checksum calculation processing section comprises:
a checksum value calculation section for executing checksum calculation processing to calculate the checksum value; and
a time determination section for comparing a margin time between said processing end limit time and said current time with said predetermined time to input a determination result thereof representative of the presence or absence of said margin to said checksum value calculation section.

3. The vehicle-mounted electronic control apparatus as set forth in claim 1, wherein said fixed number of bytes is set to a minimum value which does not influence the processing of said CPU under a high load thereof.

4. The vehicle-mounted electronic control apparatus as set forth in claim 1, wherein said processing end limit time is set to a point in time that is obtained by adding a maximum processing permissible time, which is permitted for one execution of said periodic processing, to said current time.
